(19) United States
(12) Patent Application Publication
(10) Pub. No.: US 2002/0059211 A1
(43) Pub. Date: May 16, 2002

(54) System for managing objects based on position data

(75) Inventor: Shingo Kuramochi, Yashio-shi (JP)

Correspondence Address: David R. Irvin, IBM Corporation, T81/503, PO Box 12195, Research Triangle Park, NC, 27709, US

(73) Assignee: International Business Machines Corporation, Armonk, NY

(21) Appl. No.: 09/970,968

(22) Filed: Oct. 3, 2001

(30) Foreign Application Priority Data
Oct. 5, 2000 (JP) 2000-306684

(51) Int. Cl. G06F 7/00

(52) U.S. Cl. 707/3

(57) ABSTRACT

A management system that identifies a position of each machine, article, or the like to be managed and displays the position so that a maintenance worker can manage data about such machines efficiently. A management system is configured by a host computer that holds a database for machines to be managed, and a terminal used to receive the latest database for such machines periodically from the host computer. The terminal searches for a target machine in the database and displays a position of the target machine on a floor map displayed on the display device. The database is managed by the host computer. The database may also be provided with an editing application program used to edit each apparatus mark to be displayed as the position of a target apparatus on the floor map.

### FIELD OF THE INVENTION

The present invention relates to a system for managing objects such as computers, more particularly to a system to help identify and locate an object to be managed more efficiently.

### BACKGROUND

Failure recovery, inventory and maintenance in a computing center having many hardware machines (hereinafter, to be referred to simply as machine(s) such as large-scale computers, takes much time and labor. This is because an object machine must be identified from among those many machines. Identifying an object machine requires a management list that includes at least management numbers, machine types, installation places, etc. of machines, as well as maps that denote places of those machines on floors of an actual computing center.

In order to do maintenance or management work the responsible person needs to search the management list for information related to a target machine from. Then, the person obtains information about the installation place of the machine from the searched information, and goes to the installation place with reference to a map in order to carry out the required maintenance/management work.

Needless to say, the above-described method requires considerable labor to keep the information described on the management list and map updated. In addition, when the maintenance person takes the map away to a maintenance site, other persons cannot use the map. In order to avoid such a problem, a plurality of management lists and maps may be prepared. This requires even more labor in order to keep the information updated.

Although a management list might be held as a database and managed by a computer, this would require considerable labor to create and maintain a map in accordance with actual disposition of an installation floor even when a CAD (Computer Aided Design) program is used. Moreover, objects to be managed have various types of attribute information, so that the management of those objects becomes more complicated.

For example, many companies employ outsourcing providers under contract. Concurrent with this trend, many computer makers now provide maintenance and management of computers held in a computing center. In such a case, the number of machines to be maintained and managed increases significantly, and the above-described problems therefore become increasingly severe. These problems are common not only for maintenance and management of machines in computing centers, but also for maintenance and management of facilities in factories, as well as merchandise stock control in corporations, stores, warehouses, and book management in libraries.

### SUMMARY

A management system according to the present invention includes a host computer that holds position data of each object to be managed, and at least one portable terminal machine. The portable terminal machine displays the position of the object according to the position data received from the host computer through data communication means.

The portable terminal machine receives a database from the host computer. The database may store both position information and attribute information. Attribute information may be information used to identify an object, information used to search the object in the database, and other various information items about the object itself to be displayed on the portable terminal machine.

The portable terminal machine can search data in the database according to a retrieval condition entered by a user and display the position of the object whose attribute information matches the retrieval condition.

It is also possible to synchronize data between the databases held by the host computer and by the portable terminal machine. When the host computer manages the database, the portable terminal machine can keep the database updated regardless of the number of portable terminal machines employed by the host computer.

Data communication between the host computer and each terminal machine is preferably wireless, for example using Bluetooth transceivers, infrared communications, and so forth.

A search system according to the present invention enables the portable terminal machine to search object information in the database received from the host computer, and identify the object to be managed, such as a user-specified machine or article, and display the position of the object on a map according to the position information related to the identified object. Consequently, the database can be searched efficiently for the object. Also in this case, the host computer preferably manages the database.

The portable terminal machine of the present invention can search data in the database according to the retrieval condition entered by the user and identify an object that satisfies the retrieval condition. The position display apparatus can also display the position of the identified object on a map, so that the user may find the object easily. In addition, the portable terminal machine can display management information of an identified object. The portable terminal machine may receive a database that includes map data, object coordinate data, external object management data, for example, from a host computer.

The host computer of the present invention manages data of each object. The host computer holds a database that includes map data, coordinate data, and management data. The host computer also enables various management data items to be stored in the database. And, because the host computer outputs the database to portable terminal machine in response to a request, the portable terminal machine can keep its database updated. The portable terminal machine is preferably able to display the position of each object with a display mark on a map according to the map data and the coordinate data together with other various information items used to manage the object on the screen.

The host computer also enables the user to draw a new display mark on a displayed map with use of the mark drawing means according to the map data stored in the database. The host computer, when obtaining coordinate data of the drawn display mark on the map stores the coordinate data in the database as the coordinate data of the display mark, and enables editing (add, change, etc.) of the display mark that denotes the position of the object.

In addition, when a reference line created with reference to a fixed item, for example a floor panel, pillar, wall, or other item that actually exists in an area, is displayed on the map, the data management apparatus can draw a display mark easily so as to match with the actual object.

The present invention may also be thought of as a position display method that stores a database including map data and position data of each of a plurality of objects, receives specification of a specific object among a plurality of the objects from the user, and displays the position of the specific object on the map according to the map data and the position data of the specified specific object.

When receiving a database related to a plurality of objects from the host computer, the method enables the host computer to update the data in the database so as to manage the database using batch processing. Furthermore, the method enables the position of each object to be displayed according to the latest database received from the host computer and updated at predetermined intervals.

The present invention may also be thought of as a program sending apparatus that enables storage means to store a program that enables a computer apparatus to execute the following processes: a process for receiving a condition input for specifying a specific object; a process for specifying a specific object according to the entered condition; a process for reading the position information of the specified specific object from a database; and a process for displaying the position of the specific object according to the position information. The program sending apparatus reads the program from the storage means, and enables sending means to send the program to the computer apparatus. Consequently, the computer can display the position of each user specified object. Such a program sending apparatus may be suitable for installing the program in an existing portable information terminal, and so forth.

In addition, the program as described above can also be stored in such a storage media as various chip memories, so that it can be read by a computer apparatus.

The present invention may also be thought of as a storage medium that stores a program used to make a computer apparatus execute the following processes: a first process for displaying a map according to the map data; a second process for drawing a display mark on the displayed map according to an external input; a third process for obtaining coordinate data of the drawn display mark on the map; and a fourth process for storing the obtained coordinate data in a database so as to be related to the data of the management object specified externally.

The program may also cause the computer apparatus to execute a process for reading data of an object to be managed, which data is not related to any coordinate data, from the database, and a process for requesting specification of a management object to be related to coordinate data in the fourth process before the first or second process. Such a storage medium may be a CD-ROM, DVD, memory, hard disk, or the like.

### BRIEF DESCRIPTION OF THE DRAWINGS

FIG. 1 shows a configuration of a management system in an embodiment of the present invention;

FIG. 2 shows configurations of a host computer and a terminal;

FIG. 3 shows an example of data in a database held by the host computer and the terminal respectively;

FIG. 4 shows an example of a floor map displayed on a screen of the terminal;

FIG. 5 shows exemplary screens for displaying data in the terminal. FIG. 5(a) is an initial screen and FIG. 5(b) is a screen displayed when “Layout” is selected on the initial screen;

FIG. 6 shows other exemplary screens for displaying data in the terminal. FIG. 6(a) is the initial screen, FIG. 6(b) is a screen displayed when “HW retrieval” is selected on the initial screen so as to enter a search condition, FIG. 6(c) is a screen for displaying the search result, and FIG. 6(d) is a screen for displaying detailed information of a specified machine;

FIG. 7(a) is another screen to enter a search condition and

FIG. 7(b) is a screen for displaying the search result;

FIG. 8 is a screen displayed when “Search layout” is selected on the search condition input screen;

FIG. 9 is a screen displayed when “Option” is selected on the search condition input screen;

FIG. 10 is a flowchart for processes executed up to the registration of a machine mark with use of an editing application program;

FIG. 11 is an example of a window displayed when the editing application program is started up so as to register a machine mark;

FIG. 12 is a window displayed after the window shown in FIG. 11 and enabled to register a machine mark;

FIG. 13(a) shows data displayed when a machine to be registered is specified and FIG. 13(b) shows an expanded view of part of the data shown in FIG. 13(a);

FIG. 14 shows information of a machine to be registered, displayed in part of the data shown in FIG. 13(a);

FIG. 15 shows a machine mark editing screen; and

FIG. 16(a) shows data displayed when a machine mark is generated, and FIG. 16(b) shows a partially expanded view of the data shown in 16(6).

### PREFERRED EMBODIMENT

Hereunder, the preferred embodiment of the present invention will be described in detail with reference to the accompanying drawings. In the embodiment of the present invention, the management system, the search system, the portable position display apparatus, the data management apparatus, the position display method, and the storage medium of the present invention are employed for maintenance/management work in an outsourcing business with a plurality of customers.

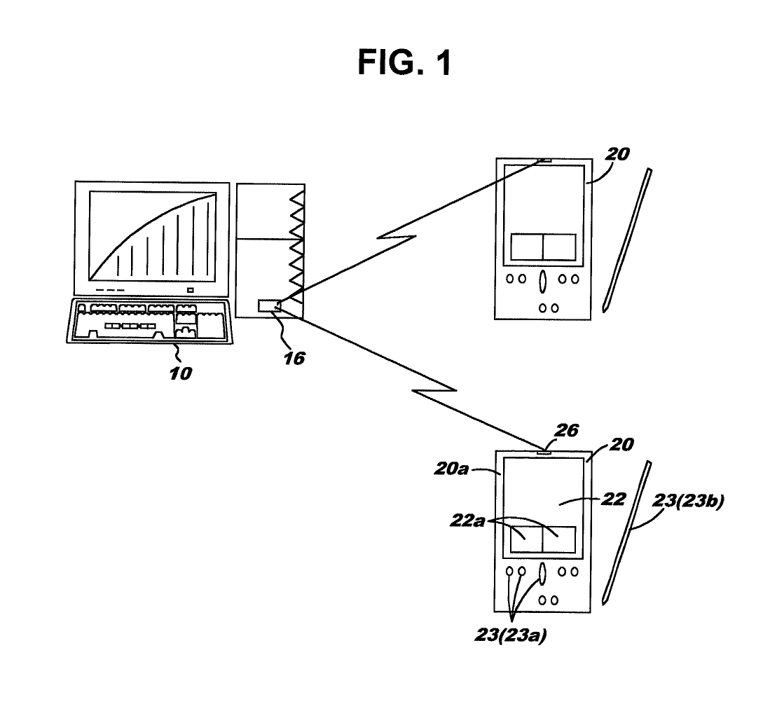

FIG. 1 shows a configuration of a management system in the embodiment of the present invention. This management system comprises a host computer (host apparatus, data management apparatus, host side) 10 that manages a collection of machines (management objects) installed in a management area, and a plurality of portable terminals (portable position display apparatus, external terminals) 20 enabled for data communication with the host computer 10. The management system in this embodiment manages information related to those machines by the host computer 10, integrating the information in a database. The host computer 10 transfers database information to each of the terminals 20. Each terminal 20 searches for a target machine and displays the place of the target machine on a map according to the information in the database transferred from the host computer 10.

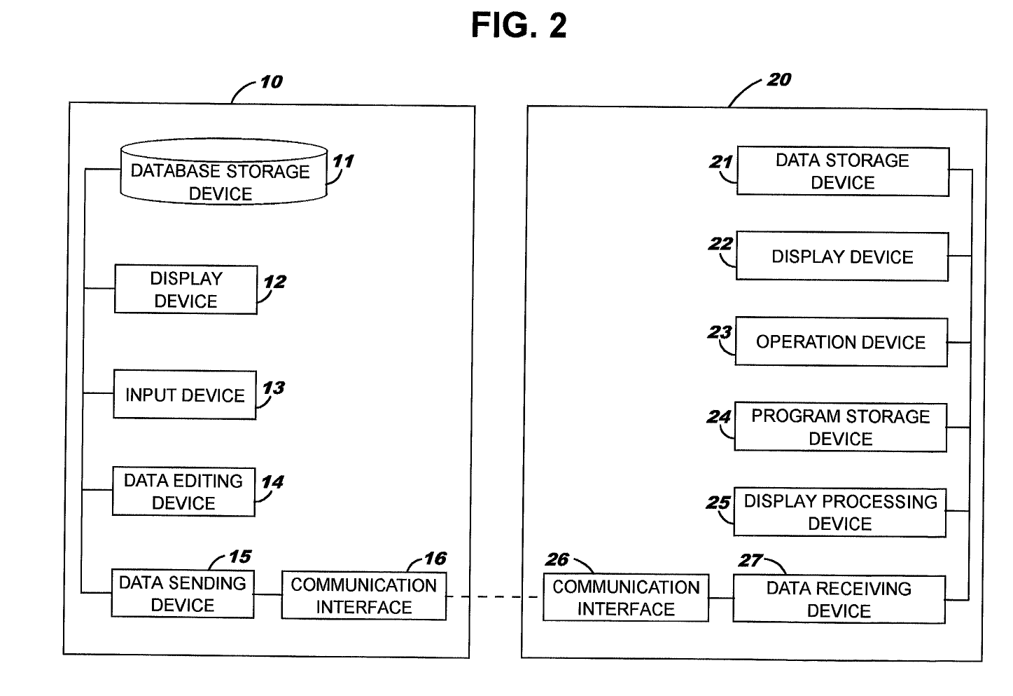

As shown in FIG. 2, the host computer 10 is provided with a database storage device (database storage means) 11 for storing a database; a display device 12 for displaying information related to the database; an input device 13 for entering information to the database; a data editing device 14 for editing data stored in the database; a data sending device (database output means) 15 for sending information related to the database externally; and a communication interface 16 used for data communications with each terminal 20.

If data is not required to be displayed, entered, or edited at the host side, the display device 12, the input device 13, or the data editing device 14 may be omitted. In such a case, the host computer 10 may be configured so that data are input, output, and edited by remote access via the communication interface 16.

Each terminal 20 is provided with a data storage device (data storage means) 21 for storing database information transferred from the host computer 10; a display device, preferably of a touch panel type (map display means) 22 for displaying and entering A various data items; an operation device (condition input means) 23; a program storage device 24 for storing a program used to control data displayed on the display device 22; a display processing device (searching means, map display means) 25 for executing a process according to the program stored in the program storage device 24; a communication interface 26 used for information communication with the host computer 10; and a data receiving device (data receiving means) 27 for receiving external data and storing the data in the data storage device 21.

As shown in FIG. 1, the operation device 23 is provided with a plurality of buttons 23a on a housing 20a of each terminal 20, as well as a stylus pen 23b. The stylus pen 23b is used to select an item on the display device 22 that is also used as a touch panel, as well as to enter characters, numbers, etc. in an input area 22a set on the display device 22.

The display processing device 25 searches data stored in the data storage device 21 and displays the searched data on the display device 22 according to the condition entered via the operation device 23. This display processing device 25 can also function as map display means for displaying the installation place of each user specified apparatus on the display device 22.

The Workpad (a product name of a portable information terminal, of IBM Corporation) is suitable for use as the display terminal 20.

Data communication is enabled between the communication interface 16 of the host computer 10 and the communication interface 26 of the terminal 20 by the use of, for example, infrared or other wireless communication means. Data communication may also be enabled between interfaces 16 and 26 via a connector or the like.

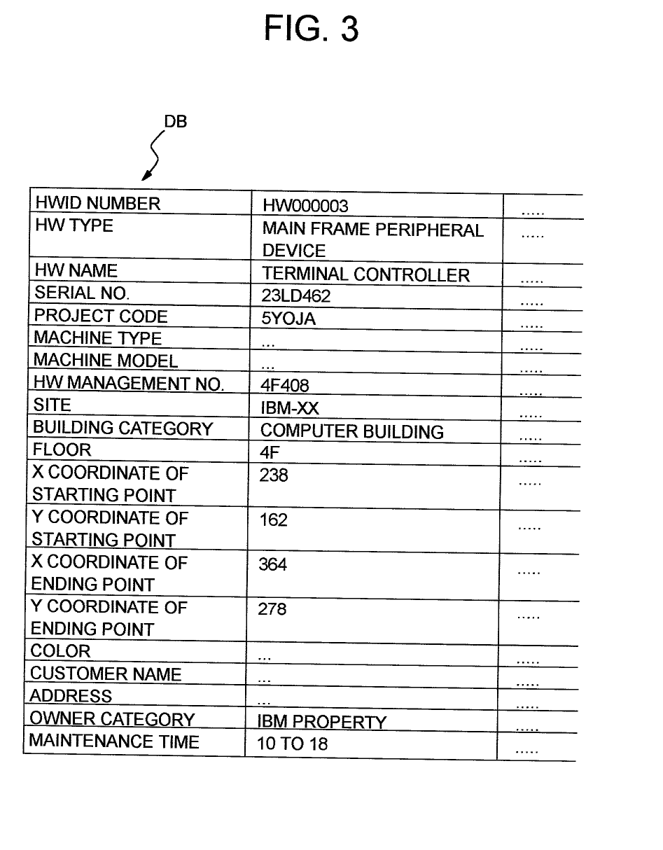

FIG. 3 shows an example of the database DB (for machines), which is stored in the database storage device 11 (and in the data storage device 21). As shown in FIG. 3, the machine database stores attribute data used to identify each of the machines to be managed, together with (i.e., in relation to) the position data used to display the installation place (management place) of the machine. Those data items can also be used for searching (to be described later). The attribute data stored in the machine database is, for example, the following information about machines themselves.

A number used to identify machine information . . . “HWID number”

A type used to classify machines . . . “HW type” (ex., CPU: Central Processing Unit, DASD: Direct Access Storage Device, etc.)

A commonly known name used to identify each machine . . . “HW name”

A “serial number” specific to each machine

A “machine type” used to identify each machine type

Information regarding customers who use machines is, for example, as shown below.

A “project code” used to identify an object contract or the like

A “customer name” used to identify a customer

A “contact address” of a customer.

In addition to the information items described above, other various information items such as “a maintenance time” for denoting a time band in which maintenance/management work is to be done for an individual machine can be stored in the machine database.

The machine database also stores the following position data useful for displaying the position of each apparatus installed on a floor (area).

A “HW management number” denoting the installation place of each machine

A “site” that is a name used to identify the place of each building in which a target machine is installed.

A “building category” used to identify a building from others when a plurality of buildings exist on a site.

A “floor” denoting a floor of a building, on which a target machine is installed.

Positional information, which may be coordinate data such as “starting point X”, “starting point Y”, “ending point X”, and “ending point Y”

A “color” used to display the position of an apparatus installation place.

These information items are stored in the database so as to be related to the information of each machine.

The machine database also stores map data of an entire area (management area, specific area) to be managed in the management system. This map data is used to form a map partitioned by site, building, floor, or the like, respectively. In this embodiment, the database stores map data used to form a map for each floor, etc. The position information and the coordinate data of each machine are related to this map data and stored in the machine database. More specifically, map data is related to coordinate data such as “starting point X”, “starting point Y”, “ending point X”, and “ending point Y” for denoting the position of each machine on a subject floor. Consequently, the position and shape of each machine on the subject floor can be displayed on a map.

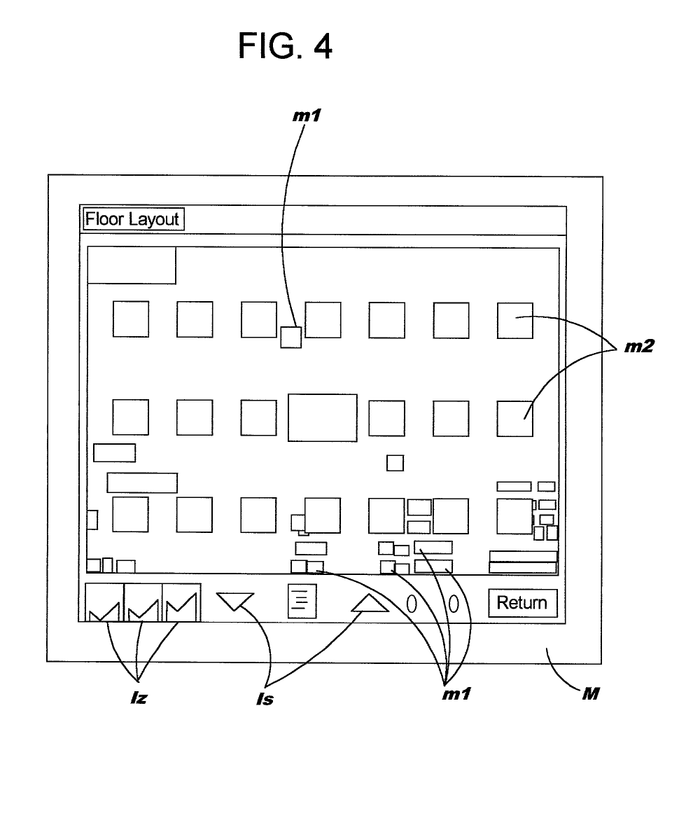

FIG. 4 shows a map created according to such map data. This floor map M displays the shape of a floor, as well as machine marks (display marks) m1 for denoting both position and shape of each apparatus installed on the floor, and fixed item marks m2 for denoting such a fixed item as a pillar on the floor so as to denote the layout of the whole floor. A machine mark m1 has an area displayed on the floor map M with coordinate data of “starting point X”, “starting point Y”, “ending point X”, and “ending point Y”. A fixed item mark m2 denotes a pillar or the like, and is displayed as a mark (landmark) for enabling the user to know the position of a target apparatus on an actual floor when the user looks at the position of a machine mark m1 on the floor map M.

In this management system, the editing device 14 of the host computer 10 updates information in the machine database, stored in the database storage device 11, when a machine is added or deleted, or information of a machine is updated. Each terminal 20 preferably obtains the latest machine database from the host computer 10, for example when maintenance/management work begins, or at fixed intervals. Consequently, the terminal 20 can synchronize with the host computer 10 with respect to the data in both machines' databases.

The terminal 20 employed in this embodiment is a portable information terminal, which is provided with a so-called synchronizing (Sync) function. This function provides data synchronizing means.

When the operation device 23 executes a predetermined operation, the terminal 20 requests preset data from the host computer 10 via the communication interfaces 16 and 26 according to the program stored in the display processing device 25. In response to this request, the host computer 10 outputs data in the machine database stored in the database storage device 11 via the data transmission device 15 as the requested preset data, according to a predetermined program stored in such storage means as a hard disk drive or the like. The output data is received by the data receiving device 27 of the terminal 20 through the communication between the communication interfaces 16 and 26 and stored automatically in the data storage device 21 of the terminal 20. In this way, the synchronizing function of the terminal 20 can be used to fetch the machine database automatically from the host computer 10.

The terminal 20, when holding a machine database received from the host computer 10 in the data storage device 21, executes the following processes so as to display a screen on the display device 22 according to the program stored in the program storage device 24.

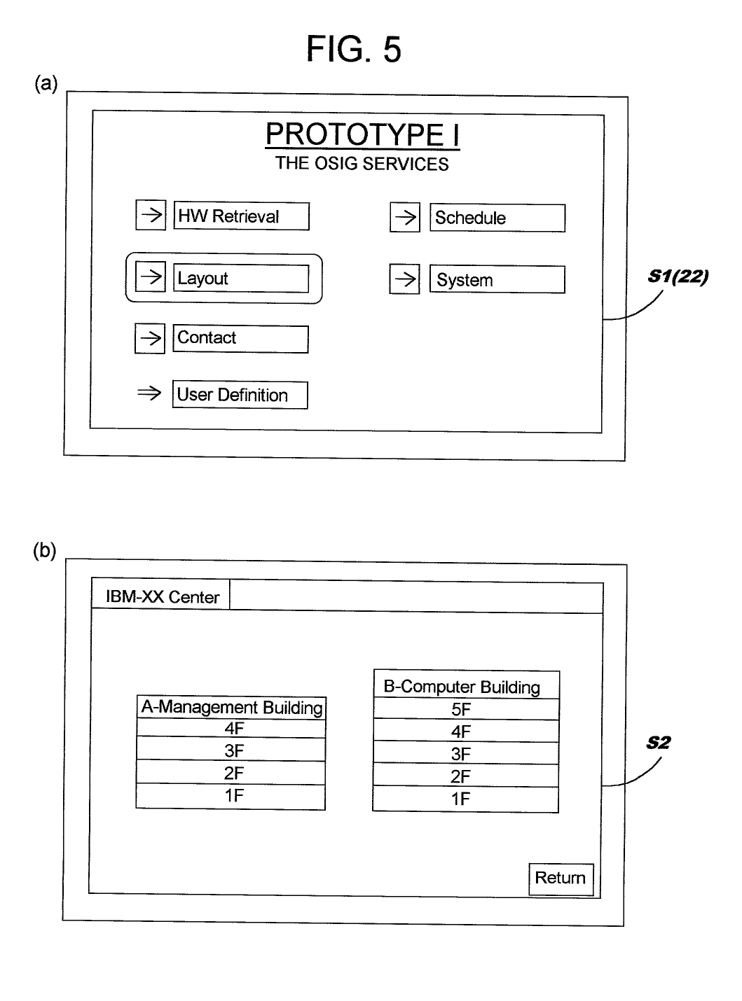

The terminal 20 displays the initial screen S1 as shown in FIG. 5(a) on the display device 22. On this initial screen S1 are displayed menus. When the user selects, for example, “layout” via the operation device 23 (tapping a point on the display device (touch panel) with use of the stylus pen 23b), the screen S2 shown in FIG. 5(b) is displayed.

On the screen S2 is displayed the maximum sized layout stored in the machine database. In this embodiment, the machine database stores only the data related to “IBM-XX Center” as an example. The screen S2 displays a floor configuration about “management building” and “computer building” (equivalent to “building category”) of “IBM-XX Center” (equivalent to a “site”).

When the user selects a target floor on this screen S2 via the operation device 23, the selected floor map M (FIG. 4) is displayed. While this floor map M is displayed as shown in FIG. 4, the user can use the scale-up/scale-down icon Iz and the scroll icon Is to, for example, change the display magnification of the floor map M or change the display range.

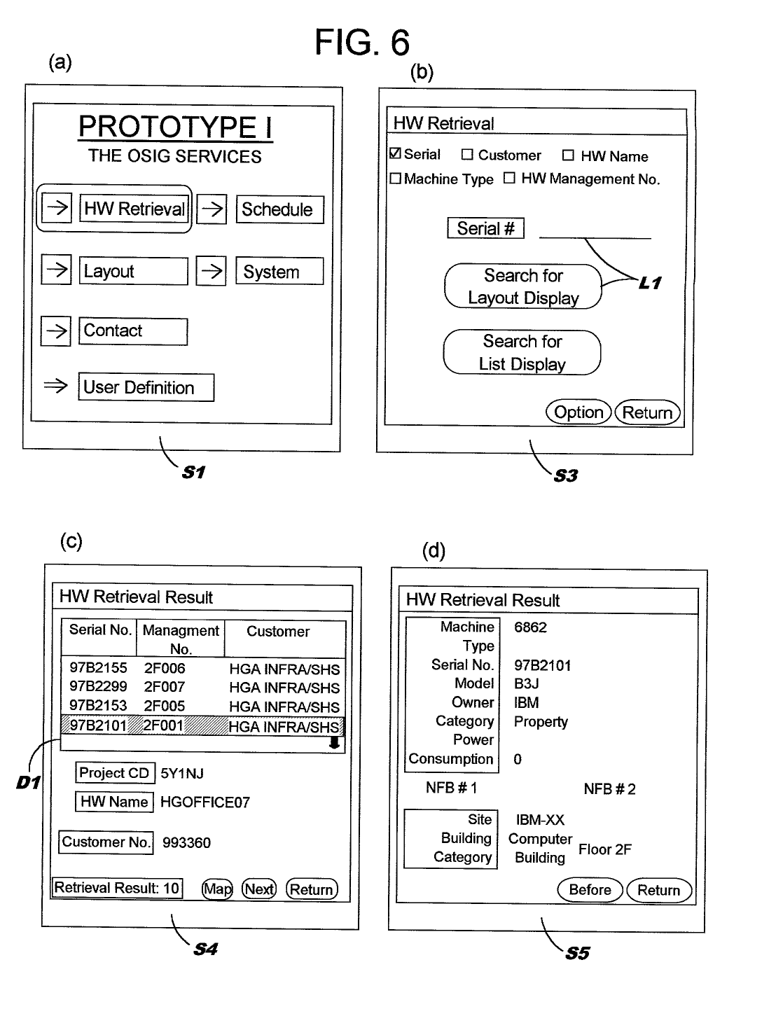

For example, when “HW retrieval” is selected on the initial screen S1 as shown in FIG. 6(a), the search screen S3 is displayed as shown in FIG. 6(b). On this search screen S3 are displayed, for example, “Serial”, “Customer”, “HW name”, “Machine type”, and “HW management number” items as retrieval or search conditions. “Serial” is equivalent to “serial number” and “Customer” is equivalent to “customer name” in the machine database shown in FIG. 3 respectively.

When “Serial” is selected, the serial number (Serial NO) input field L1 is displayed on the search screen S3 and the user is prompted to enter the serial number of the machine to be searched. When the user enters a target machine serial number (at least part of it) in the input field L1 with use of the stylus pen 23b or the like on the operation device 23 used as condition input means, and selects “search for list display”, the display processing device 25 searches the data in the machine database stored in the data storage device 21. When the target machine corresponding to the serial number entered in the input field L1 is found, the search result screen S4 is displayed as shown in FIG. 6(c). On this search result screen S4 is displayed part of the information of the target machine (“Serial No.”, “Management No.”, “Customer” at this time) in the display field D1. When a plurality of the target machines exist at this time, the list of the machines is displayed in the display field D1. Under the display field D1 is displayed information of the machine on which the cursor is positioned in the display field D1 (“Project CD (project code)” x “HW name”, and “Customer No.” at this time) and the “Search result”, which denotes the number of data items matching with the search condition.

A When the user selects “Map” from the information of the machines in the list in the display field D1 on this search result screen S4 while the cursor is positioned on the identified information about the target machine, the floor map M (FIG. 4) of the floor on which the target machine exists is displayed. In this case, the target machine mark m1 is highlighted by blinking or the like on the floor map M.

When the user selects “Next” in the display field D1 on the search result screen S4 while the cursor is positioned on the information of the target machine, the display screen S5 is displayed on the display device 22 as shown in FIG. 6(d) according to the program stored in the program storage device 24 used as the management information display means. On this display screen S5 is displayed detailed information about the target machine from the machine database. When the user selects “Before” on the display screen S5, control goes back to the search result screen S4 as shown in FIG. 6(c).

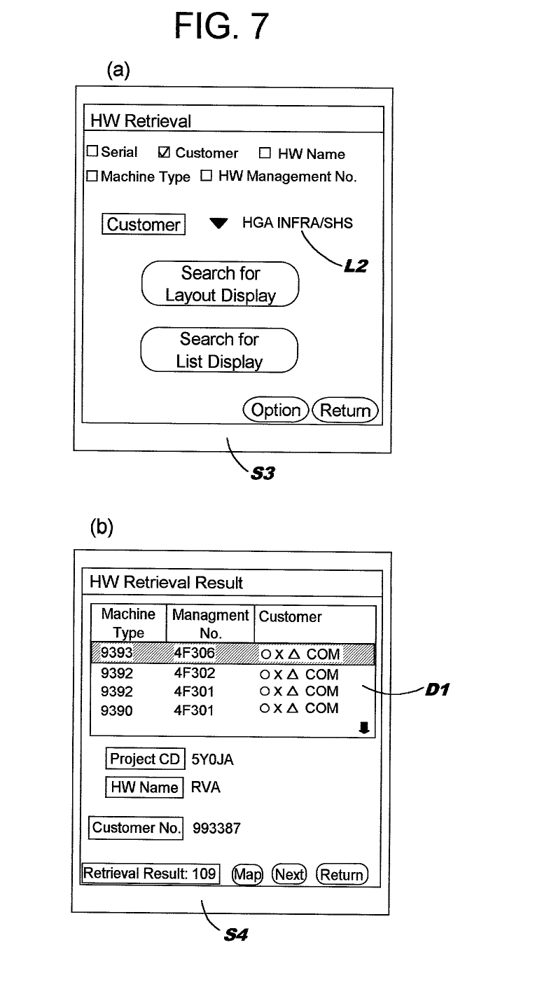

On the search screen S3 shown in FIG. 6(b), the user can also search data with respect to each of the items “Customer”, “HW name”, “Machine type”, and “HW management No.” instead of “Serial”. For example, when the user selects “Customer” on the search screen S3 as shown in FIG. 7(a), the input field L2 is displayed so as to prompt the user to enter a customer name.

When the user selects “search for list display” after entering a customer name in the input field L2 via the operation device 23 used as the condition input means, the display processing device 25 searches for data matching with the input condition (retrieval condition) in the machine database stored in the data storage device 21. The search result is then displayed on the search result screen S4 as shown in FIG. 7(b). In the display field D1 on this search result screen S4 is displayed a list of the machines matching with the customer name entered in the input field L2.

When the user selects “Map” in the display field D1 on the search result screen S4 while the cursor is positioned on the information of the target machine (specific machine) among the machines in the list, the floor map M shown in FIG. 4 is displayed and the machine mark m1 corresponding to the target machine is highlighted by blinking or the like on the display.

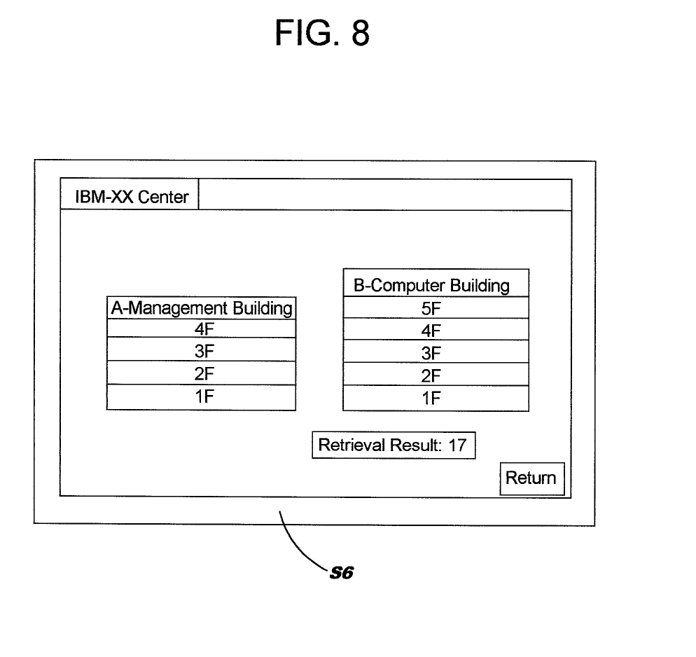

When the user selects “Next” on the search result screen S4, the display screen S5 (detailed information about machines) is displayed as shown in FIG. 6(d). When the user selects “search for layout display” on the search screen S3 shown in FIG. 6(b) or FIG. 7(a) after selecting/entering a predetermined search item, the display screen S6 as shown in FIG. 8 is displayed. On this display screen S6 is displayed the number of machines matching with the search condition as the “search result”, then the floor corresponding to the target machine, that matches the search condition is highlighted by blinking or the like on the display. When the user selects one of the highlighted floors via the operation device 23, the floor map M (FIG. 4) of the floor is displayed, and the machine mark m1 corresponding to the apparatus matching with the search condition is highlighted on the floor. When there are a plurality of target machines at this time, a plurality of the corresponding machine marks m1 are highlighted.

This layout display search can be employed effectively for maintenance/management work of all the machines of a given type.

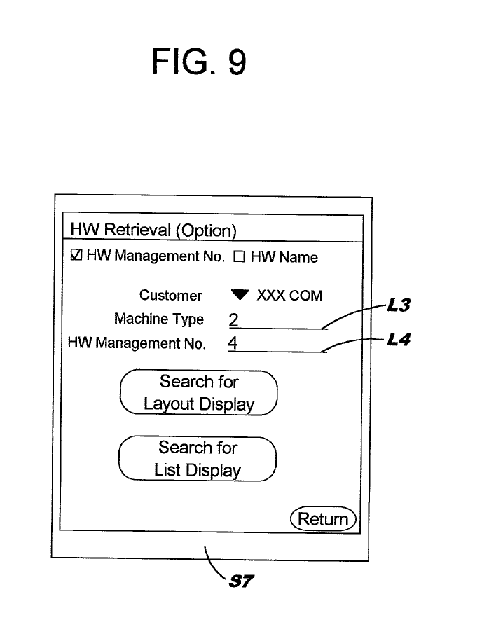

When the user selects “Option” on the search screen S3 shown in FIG. 6(b) or FIG. 7(a), the display screen S7 shown in FIG. 9 is displayed. On the display screen S7 are displayed two input fields L3 and L4 so that a plurality of conditions can be combined as a condition input for searching. When the user selects “search for list display” on this display screen S7 after entering a search condition, the search result screen S4 is displayed as shown in FIG. 6(c) or FIG. 7(b). When the user selects A “search for layout display” on the screen S7, the display screen S6 as shown in FIG. 8 is displayed.

In the terminal 20, machine information is searched in the machine database stored in the data storage device 21, thereby the position of the target machine matching with the search condition on the floor can be displayed on the floor map M. Consequently, the user (maintenance/management manager) can recognize the position and information of the target machine on the floor map M.

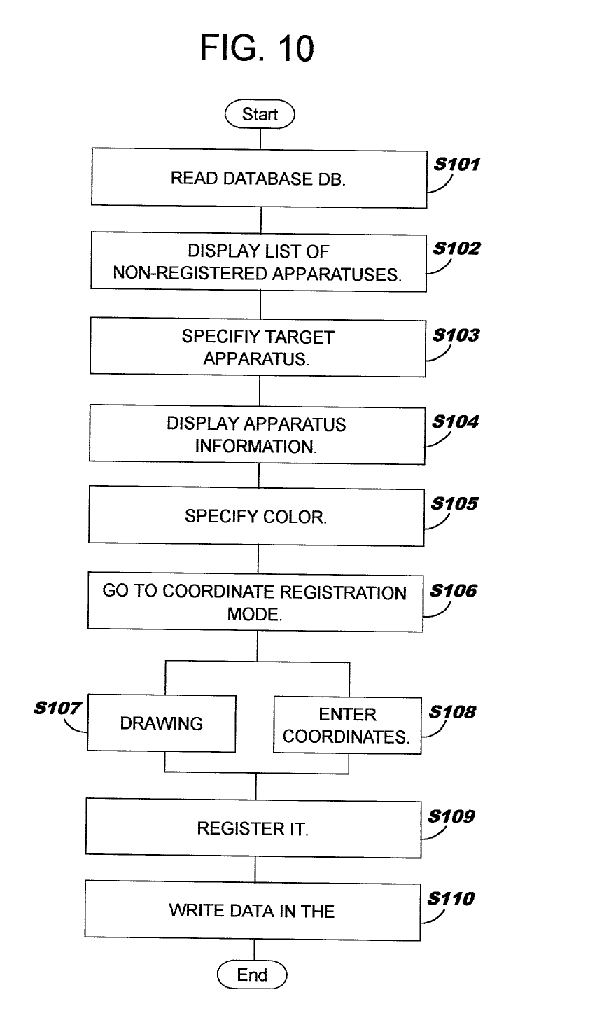

In this management system, the data editing device 14 of the host computer 10 updates the information in the machine database, for example when a machine is added/deleted or the layout of a machine is changed. For such updating, the user need only enter/delete each item of machine information as shown in FIG. 3 or modify the data in the machine database. However, for the coordinate data “starting point X”, “starting point Y”, “ending point X”, and “ending point Y” to be entered so as to generate a machine mark m1 on a floor map M, an editing application program should be used so as to make it easier to register coordinate data on a floor map M. Hereinafter, the processing of such an editing application program will be described with reference to the flowchart shown in FIG. 10.

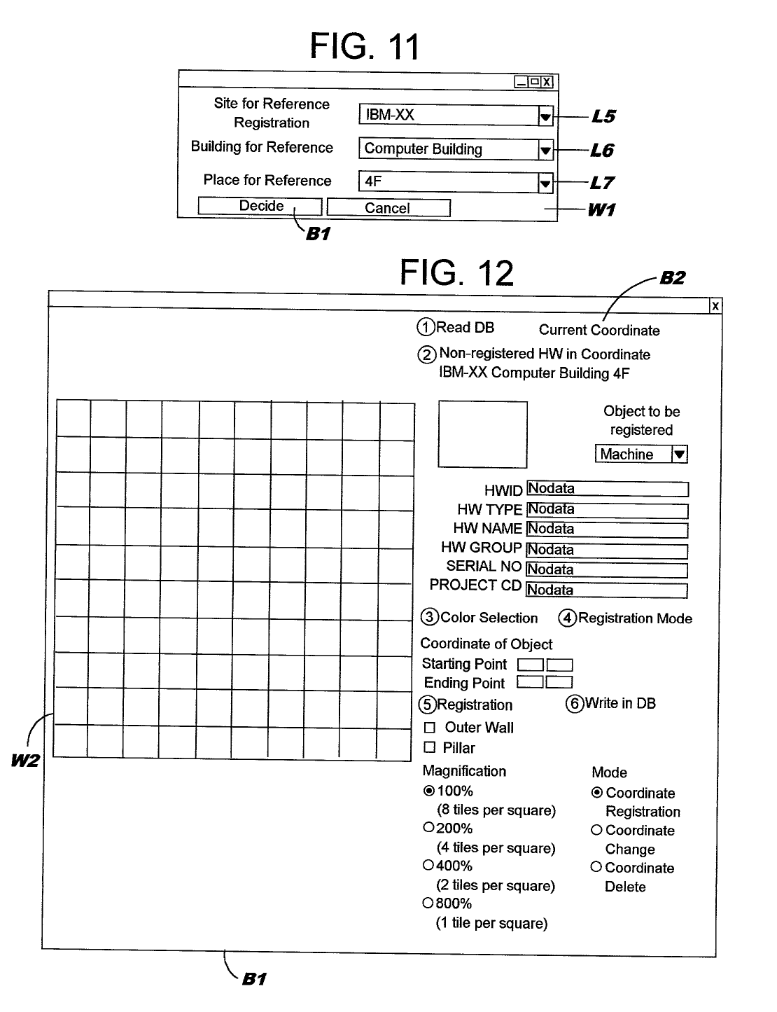

This editing application program is stored in storage means such as a hard disk of the host computer 10 or the like. When the program is started up as needed, the display device 12 displays a window W1 as shown in FIG. 11. In this window W1 are displayed input fields L5, L6, and L7 of “Site”, “Building (equivalent to the building category”), “Place (equivalent to floor)”. The user can thus enter (select) the information corresponding to a machine to be registered. When the user presses the “Decision” button B1, a coordinate registration window W2 shown in FIG. 12 is displayed.

When the user presses the “Read DB” button B2 in the displayed coordinate registration window W2, a database (the machine database in this embodiment) corresponding to the information of “Site”, “Building”, and “Place” entered in the window W1 (FIG. 11) is read from the database storage device 11 of the host computer 10 (step S101). For example, when there are a plurality of machine databases classified by area at this time, the machine database that includes the target information is selected and read according to the information entered in the window W1.

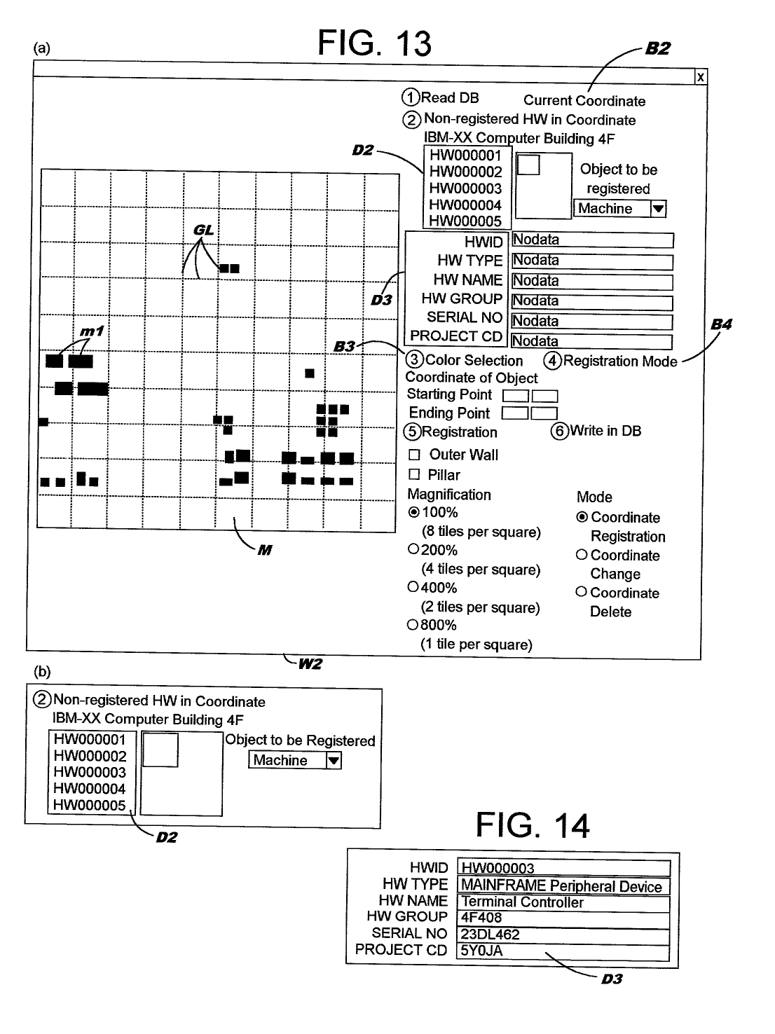

Then, the floor map M of the “place (floor)” entered in the window W1 (FIG. 11) is displayed in the coordinate registration window W2 used as map display means according to the map data stored in the read machine database as shown in FIG. 13(a). On this floor map M are displayed machine marks m1 and fixed item marks m2 (FIG. 4) denoting pillars or the like that are already registered when the machine database is read.

When a floor map M is displayed in the coordinate registration W2 at this time, a grid line (reference line) GL is also displayed. In this embodiment, this grid line GL is displayed in alignment with a floor panel, which is a fixed item on the actual floor. This is because machines are often disposed with reference to ends of the floor panel so as to lay cables under the floor. Consequently, in such a case, when the editing application program is configured to display the grid line GL in alignment with the actual floor panel, it is possible to adjust the position of each machine mark m1 on the floor map M in the coordinate registration window W2 easily to the position of each machine on the actual floor.

On the other hand, when the machine database is read in step S101 as described above, a search is done for each apparatus for which none of the coordinate data of “starting point X”, “starting point Y”, “ending point X”, and “ending point Y” used to generate a machine mark m1 is registered in the machine database. As a result of the search, a list of machines for which no coordinate data is registered is displayed in the machine list display field D2 in the coordinate registration window W2 (step S102) as shown in FIG. 13(b).

When the user specifies (selects) a target machine from among a list of machines displayed in the machine list display field D2, and clicks the mouse button (step S103), the information about registered machines is read from the machine database and displayed in the display field D3 (step S104).

To display a machine mark m1 in a color on the screen of the terminal 20 after this, the user is prompted to specify the color of the machine mark m1 generated corresponding to the selected machine (step S105). The user need only press the “Color selection” button B3 shown in FIG. 13(a) to specify the color in the color selection mode.

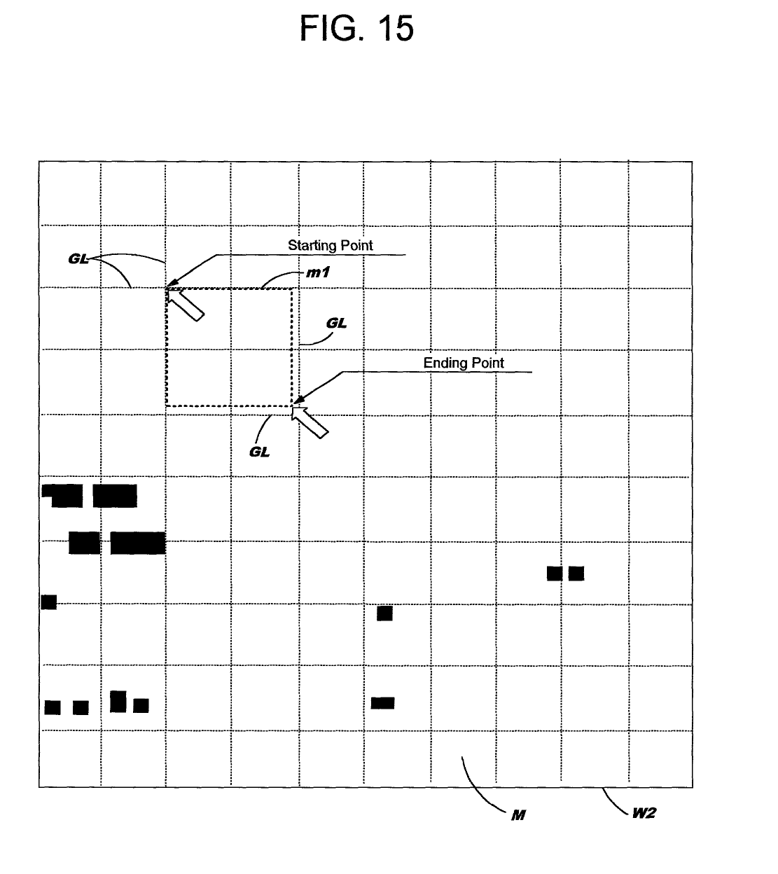

Then, the user is prompted to press the “Registration mode” button B4 to go to the coordinate registration mode for the machine mark m1 of the selected machine (step S106). The user can thus draw the machine mark m1 on the floor map X displayed in the coordinate registration window W2 (step S107) as shown in FIG. 15. In order to draw the machine mark m1, the user uses the mouse (not shown) of the input device 13 that functions as the mark drawing means so as to specify an area in which the machine mark m1 is to be registered. More specifically, the user can drag the mouse from a corner of the area in which the machine mark m1 is to be registered to another corner on the diagonal line on the floor map M so as to specify both “starting point” and “ending point” of the machine mark m1. At this time, the grid line GL displayed on the floor map M can be used as a standard for this dragging.

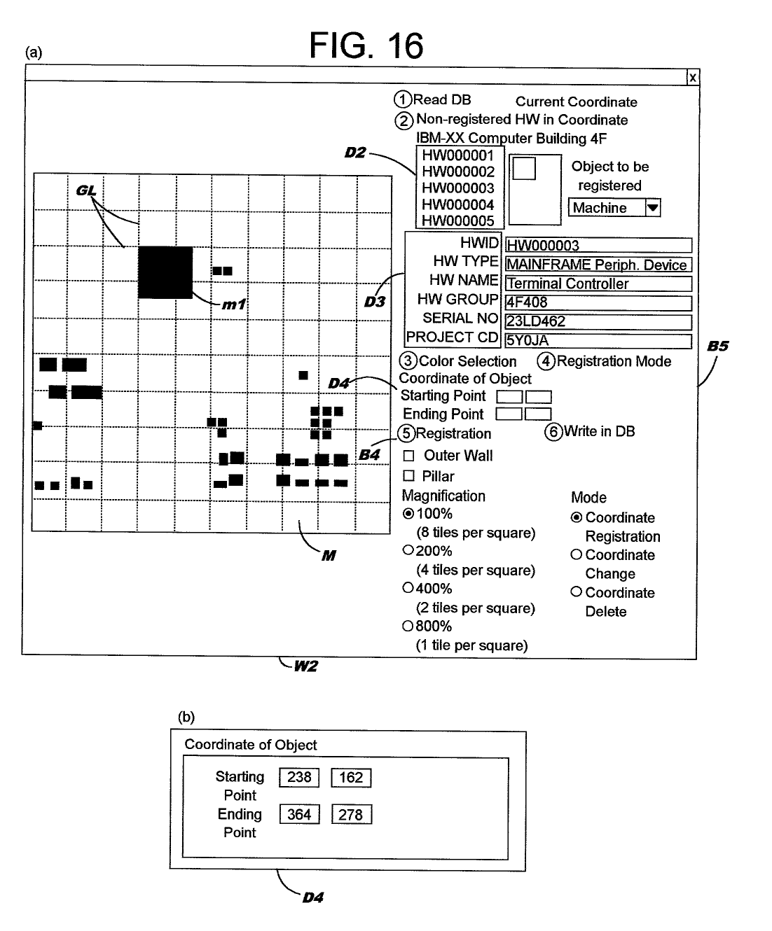

As a result, the machine mark m1 is drawn on the floor map M as shown in FIG. 16(a). Both the “starting point” and the “ending point” of the drawn machine mark m1 are processed by the editing program used as the coordinate obtaining means, thereby both X and Y coordinates on the floor map are recognized automatically and displayed in the coordinate display/input field D4 of the coordinate registration window W2 as shown in FIG. 16(b).

Instead of specifying the “starting point” and the “ending point” of the machine mark m1 as just described, it is also possible to enter both X and Y coordinates of the “starting point” and the “ending point” directly with values in the coordinate display/input field D4 of the coordinate registration window W2.

The user is then prompted to press the “Register” button B4 when both X and Y coordinates are specified for “starting point” and “ending point” of the machine mark m1 in step S107 or S108. The X and Y coordinates of the specified “starting point” and “ending point” are thus written in such storage means as a RAM, a hard disk, or the like of the host computer 10 (step S109).

After this, when the user presses the “Write in DB” button B5, the editing program used as data storage means writes the X and Y coordinates of the “starting point” and “ending point” registered in step S109 in the machine database as coordinate data of “starting point X”, “starting point Y”, “ending point X”, and “ending point Y” (step S110).

This completes registration of position information of a machine in the machine database by the editing application program. After this, the editing application program may be exited.

According to the embodiment described above, it is possible for the maintenance person to display the floor map M denoting the position of the target machine, and thereby learn the position of the subject machine easily and accurately. In addition, each terminal 20 is provided with a machine database concerning a target machine. Consequently, it is possible to obtain the position and other various types of information about each target apparatus quickly regardless of the number of machines to be managed. And, because the terminal 20 is a portable one, it is also possible to check the position and other necessary information of each target machine even at a site away from the host computer 10. Consequently, the efficiency and mobility of maintenance and management for machines are improved significantly. In addition, because a plurality of such terminals are provided, no problem occurs even when a plurality of maintenance persons work at the same time.

Furthermore, because each terminal 20 holds a machine database received from the host computer 10, the host computer 10 can manage those databases held by a plurality of terminal machines 20 collectively. This makes it easy to manage data in those databases, as well as to enable every terminal 20 to use the latest data even when the system includes a plurality of terminals 20.

The machine database also stores coordinate data of each machine mark m1 used to display the position of the machine on a floor map M so as to be related to other information of the machine. The coordinate data of the machine mark m1 can be registered easily in the host computer 10 with use of an editing application program.

Moreover, when such a portable information terminal as the Work Pad (product name) is used as the terminal 20, and a program that can execute the above-described processes is stored in the storage means, it is possible to realize a management system as described in this embodiment easily.

In order to speed up the transfer of data in the machine database between the host computer 10 and each terminal 20 in the above embodiment, however, the machine database should preferably be configured so as to be divided for each building, each floor, each maintenance person, etc. and minimize the amount of data to be transferred. For example, data of every machine to be managed in the management system may be stored in a mother database and the data of only target machines may be extracted from this mother database so as to generate a machine database to be managed for each building, for each floor, by each maintenance person. For convenience, subsets of the mother database are called here a “database” as well.

In such a case, the mother database and each machine database may be stored in the host computer 10. At this time, an existing data management tool or the like can be used to synchronize the data between the mother database and each machine database.

When many machines are to be managed or when they are distributed in many areas, a main host computer is prepared and the mother database is stored therein, so that predetermined data is transferred between the main host computer and the host computer 10 prepared in each of those areas, so as to generate a machine database from the mother database. Data synchronization may also be required between the mother database and each machine database. In this case, a host computer 10 is not required to edit any machine database. Therefore, the host computer 10 might have only means for storing the machine database and means for communicating with the terminal 20.

Further, while an infrared communication method, a radio communication method, a connector, or the like may be used for the data transfer between the host computer 10 and each terminal 20 in the above embodiment, any other communication means and data transfer means may be used. For example, when the host computer 10 is far away from a terminal 20 or when target machines are distributed in a plurality of areas, a public network may be used to data transfer between the host computer 10 and the terminal 20. A mobile telephone may also be useful as the terminal 20 in such a case.

Although a machine database is transferred from the host computer 10 to a terminal 20, it is not necessary that the entire contents of the machine database be transferred to the terminal 20, since the sync function of the terminal 20 may be used in the above embodiment. For example, the host computer 10 may transfer only selected database records stored in the database DB held therein to the terminal 20. For example, the host computer 10 may search for data about a target machine and transfer only the data related to the target machine to the terminal 20. The part of the database that is transferred is called here a “database” for convenience.

Further, although a terminal 20 receives the latest machine database periodically from the host computer 10 in the above embodiment, the periodic interval may be decided freely. For example, when a radio communication method is used for data transfer between the host computer 10 and the terminal 20, it may be possible to update the data in the machine database at one minute intervals so that the terminal 20 can receive the latest machine database substantially in real time.

The management system according to the present invention may also be used for other purposes, such as to manage merchandise stock in factories, warehouses, stores, and so on. In addition, when the management system is used in a library, information and position data of books held therein may be integrated in a database in the host computer 10 so as to make it easier to manage those books. The users of the library can also use a terminal 20 that has obtained the latest database from the host computer 10 so as to obtain detailed information and position data of each target book.

Furthermore, although the host computer 10 transfers a machine database to a terminal 20 just one way in the above embodiment, it is also possible, for example, for the terminal 20 to store its maintenance information in its machine database and transfer the data to the host computer 10 so as to update the data in the database DB held in the host computer 10.

Furthermore, a program used for displaying the position of each apparatus on the screen of the terminal 20, and an editing application program used for fetching the position of each machine mark m1 from the machine database in the host computer 10, may be provided using any of the storage media and program sending apparatus described below. Specifically, the above program to be executed by a computer apparatus may be stored in such a computer readable storage medium as a CD-ROM, DVD, memory, hard disk, or the like.

In addition to the variations described above, the above embodiment can also be modified freely without departing from the spirit of the invention.

We claim:

1. A system for managing an object positioned in a management area, the system comprising:
a host computer for holding a database in which position data of an object to be managed is stored in relation to attribute data of the object used for identifying the object;
a portable terminal machine; and
data communication means for transferring a database from the host computer to the portable terminal machine;
wherein the portable terminal machine displays a position of the object according to position data in the database transferred from the host computer to the portable terminal machine.

2. The system of claim 1, wherein the portable terminal machine includes:
a data storing unit for storing the database transferred from the host computer;
a condition inputting unit for entering a retrieval condition; and
a searching unit for searching the database according to the retrieval condition to obtain the position data from the database when the attribute data of the object matches the retrieval condition.

3. The system of claim 1, wherein the portable terminal machine includes a data synchronization unit for synchronizing data in the database stored in the data storing unit of the portable terminal machine with data in the database held in the host computer.

4. The system of claim 1, wherein the host computer includes a data synchronization unit for synchronizing data in the database stored in the data storing unit of the portable terminal machine with data in the database held in the host computer.

5. The system of claim 1, wherein the object is a computer.

6. A retrieval system, comprising:
a host computer including a database, which database is output by the host computer on request, in which retrieval information and position information of objects to be managed are held in relation to each other; and
a portable terminal machine for receiving and storing the database output by the host computer;
wherein the portable terminal machine includes: a searching unit for searching the retrieval information in the database according to a condition specified by a user to identify a match between the retrieval information and the condition and consequently to identify position information of a particular object; and a map display unit for displaying a position where the particular object is managed on a map according to the position information.

7. A portable position display apparatus for displaying a position of an object to be managed, comprising:
a data storing unit for storing a database that includes map data used to display a map of an area in which the object is positioned, position data used to locate the object on the map, and attribute data used to identify the object, wherein the position data is stored in relation to the attribute data;
a condition input unit for enabling a user to enter a retrieval condition;
a searching unit for searching the database stored in the data storing unit according to the retrieval condition to identify a match between the attribute data and the retrieval condition and consequently to identify position data of the object; and
a map display unit for displaying a position of the object on the map according to the map data and the position data in the database when a match is identified by the searching unit.

8. The apparatus of claim 7, further including a data receiving unit for receiving the database.

9. The apparatus of claim 7, further including a management information display unit for displaying management information of the object according to the attribute data in the database when the searching unit identifies the match.

10. Apparatus for managing data of an object to be managed; comprising:
a database storing unit for storing a database that includes map data used to display a map of an area in which an object to be managed is positioned, position data of a display mark that denotes the position of the object on the map, and attribute data used to identify the object; and
a database outputting unit for outputting the database to a portable terminal machine in response to a request from the portable terminal machine.

11. The apparatus of claim 10, further including:
a map display unit for displaying the map according to the map data in the database;
a mark drawing unit for enabling a user to draw a display mark on the map displayed by the map display unit;
a coordinate obtaining unit for obtaining coordinates of the display mark drawn by the mark drawing unit; and
a data storing unit for storing the coordinate data in the database as the position data of the display mark.

12. The apparatus of claim 11, wherein the map display unit, when the display mark is drawn by the mark drawing unit, displays a reference line created on the map in response to a fixed item in the area in which the object to be managed is positioned.

13. A position display method, comprising the steps of:
storing a database that includes map data used to display an area in which a plurality of objects to be managed are placed as a map, position data used to display a position of each of the plurality of objects in the area on the map, and attribute data used to identify each object in a locally unique way;
prompting a user to specify a specific object among the plurality of objects;
reading the map data and the position data of the specific object from the database; and
displaying the position of the specific object in the area on the map according to the map data and the position data read from the database.

14. The method of claim 13, wherein the database is received from a host computer and stored in the database storing step.

15. The method of claim 14, wherein the database is updated by the host computer.

16. The method of claim 15, wherein the host computer updates the database at predetermined times.

17. A computer readable storage medium that stores a program to be executed by a computer, the program enabling the computer to execute:
a first process for displaying a map based on map data and on position data of an object that is positioned and managed in a specific area, wherein the map data and the position data are stored in a database;
a second process for drawing a display mark of the object to be managed according to an input from a user on the map;
a third process for obtaining coordinate data of the drawn display mark on the map; and
a fourth process for storing the coordinate data in the database in relation to entered data of the object.

18. The computer readable storage medium of claim 17, wherein the program further enables the computer to execute a process for presenting a list of objects to be managed, read from the database, so as to prompt the user to specify a particular object to be managed and to be stored in relation to the coordinate data in the fourth process.
